(19) United States
(12) Patent Application Publication
(10) Pub. No.: US 2006/0210059 A1
(43) Pub. Date: Sep. 21, 2006

(54) Opening/close device and mobile phone provided with the device

(76) Inventor: Satoshi Kosugi, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/520,605

(22) PCT Filed: Jun. 3, 2003
(86) PCT No.: PCT/JP03/07040

§ 371 Date: Sep. 1, 2005

(30) Foreign Application Priority Data
Jul. 8, 2002 (JP) 2002-198634

(51) Int. Cl. H04M 1/00

(52) U.S. Cl. 379/433.13

(57) ABSTRACT

A purpose of the present invention is to provide an opening/closing apparatus and a portable telephone apparatus equipped with the opening/closing apparatus capable of reducing manipulation force used when housings are expanded, and at the same time, capable of making compact. The opening/closing apparatus for expanding the housings has: a base (43) which is fixed within a rotary member (41) having a substantially hollow tube shape; a fixing holder (52) which is allowed to be moved only along an inner peripheral plane direction of the rotary member (41); a driving cam portion (3A) having both a fixing cam member (51) and a first compression spring (31); a holding cam portion (3B) having a lift cam member (53) which is coupled to the fixing holder (52), a slide cam member (44) which is engaged with the base (43) and can be slid along a shaft direction, and a second compression spring (32) which is elastically provided between the slide cam member (44) and the base (43); and also, a clutch portion (3C) having a ball (55) which engages the rotary cam member (42), and a cam shaft (54) having a cam groove (54A) engaged with the ball (55), which is slid with the slide cam member (44) in an integral form along the shaft direction.

### TECHNICAL FIELD

The present invention relates to an opening/closing apparatus and a portable telephone apparatus provided with this opening/closing apparatus capable of automatically opening two housings in an one touch manner by manipulating a button, while these two housings are coupled to each other in a freely foldable manner.

### BACKGROUND ART

Various sorts of foldable type portable telephones have been developed and used among conventional portable telephones, while these foldable type portable telephones have upper-sided housings having telephone receiving portions (speakers), lower-sided housings having telephone transmitting portions (microphones), and hinge portions which rotatably couple these upper-sided housings and lower-sided housings to each other. Also, among these folding type portable telephones, for instance, such a folding type portable telephone is known which has a compact opening/closing apparatus as shown in FIG. 15 at a hinge portion thereof.

As indicated in this drawing, this compact opening/closing apparatus is constituted by a rotary member 101, a rotary cam 102 which is engaged with a fixing shaft 103 in a pivotable manner within the rotary member 101, the fixing shaft 103 which is fixed within the rotary member 101, a fixing cam 104 which is arranged opposite to the rotary cam 102 and the sliding operation of which is permitted only along a shaft direction with respect to the fixing shaft 103, a twist spring 105 which gives rotating force to the rotary cam 102, a compression spring 106 which gives meshing force to the rotary cam 102 and a cam portion located opposite to the fixing cam 104, and a pusher 107. In the pusher 107, a coupling shaft 107A is fixed to the fixing cam 104 in order to slide the fixing cam 104 along the shaft direction when the meshing condition of the above-described cam portion is released, while the coupling shaft 107A is inserted into the fixing shaft 103 in a slidable manner.

In this compact opening/closing apparatus, the rotary member 101 is fixed to the upper-sided housing having the telephone receiving unit, and the fixing shaft 103 is fixed to the lower-sided housing having the telephone transmitting unit, and also, both the upper-sided housing and the lower-sided housing have been coupled to each other in the foldable manner while this compact opening/closing apparatus is employed as a hinge portion. It should be noted that reference number 108 indicates a fixed plate and reference number 109 shows a spacer.

As a consequence, in the compact opening/closing apparatus having such a structure, in FIG. 15, when both the upper-sided housing and the lower-sided housing are rotated to be overlapped with each other (namely, housings are closed) against twisting force of the switch spring 105, the rotary cam 102 is engaged (meshed) with the cam portion of the fixing cam 104, and thus, the portable telephone is held under folded condition. As a result, this portable telephone can be portable in compact.

On the other hand, when the portable telephone is used, when the pusher 107 is depressed via a button (not shown), since the fixing cam 104 is slid in a right direction along the shaft direction of the fixing shaft 103 and thus the meshing condition of the cam portion is released, the rotary member 101 is rotated via the rotary cam 102 by receiving the rotating force of the twist spring 105, and therefore, the upper-sided housing is opened.

As previously explained, the conventional compact opening/closing apparatus is constructed as follows: That is, the portable telephone can be folded and can be stored in compact when the portable telephone is portable, whereas the housings of the portable telephone can be expanded (opened) by manipulating the button in the one touch manner when the portable telephone is used.

On the other hand, in the conventional compact opening/closing apparatus having the above-described structure, when the portable telephone is opened in the one touch manner, the button must be depressed against the compressing force of the above-described compression spring. However, in order to hold the folding condition of the portable telephone when the portable telephone is not used under usual condition, this compression spring must have sufficiently strong locking force by which the rotating force of the twist spring can be suppressed.

In this case, this locking force “F” of the compression spring is exclusively determined by the following equation, namely,
F=(spring force)×(meshing diameter of cam portion).

However, in the above-described opening/closing apparatus, since the compactness thereof is required, there is a trend that the meshing diameter necessarily becomes small. As a consequence, in order to secure the required locking force “F”, the compressing force of the compression spring must be increased by such a value equivalent to the decreased meshing diameter. In connection to this fact, there is such a problem that the more the opening/closing apparatus is made compact, the larger the button manipulating force required to opened the housings of the portable telephone is increased, resulting in deteriorations of operability thereof.

The present invention is made to solve the above-described problem, and therefore, has an object to provide an opening/closing apparatus and a portable telephone apparatus equipped with this opening/closing apparatus which can be made compact, and at the same time, is capable of reducing manipulating force required when housings are expanded.

### DISCLOSURE OF THE INVENTION

To solve the above-described problem, an opening/closing apparatus, according to the present invention, is featured by such an opening/closing apparatus for automatically releasing/opening two housings which are coupled to each other by a hinge portion and are capable of being opened/closed by manipulating a button, comprising:

a rotary member, having a substantially hollow tubular shape;

a base, integrally fixed within the rotary member;

a fixing holder, provided with a through hole along a center axis direction thereof;

a driving cam portion, including:
a rotary cam member, which is engaged with the rotary member and which is slidable only along a shaft direction;
a fixing cam member, which is integrally fixed to the fixing holder and is arranged opposite to the rotary member; and
a first compression spring, which is elastically provided between the rotary cam member and the base;

a holding cam portion, including:
a lift cam member, which is coupled to the fixing holder;
a slide cam member, which is engaged with the base, which is slidable only along the shaft direction, and is arranged opposite to the lift cam member; and
a second compression spring, which is elastically provided between the slide cam member and the base, the elastic force of the second compression spring is smaller than that of the first compression spring; and

a clutch portion, including:
a ball, which is slidably held by the fixing holder along a radial direction on a plane perpendicular to an axis and which engages the rotary cam member at a slidable end thereof; and
a cam shaft, which is slidably held only along the shaft direction by the fixing holder, which has a cam groove engaged with the ball, and which is slid with the slide cam member in an integral manner along the shaft direction.

In the above arrangement, the clutch is formed by the second compression spring having the weak elastic force irrespective of the first compression spring having the strong spring force, which produces the driving torque. As a result, when the portable telephone is opened, the button is merely pushed by stronger force than that of the second compression spring, so that the manipulation can be readily performed.

Also, an opening/closing apparatus of the present invention is featured by that the rotary cam member includes an engaging portion which is engaged by the ball, and the rotary cam is constituted so as to execute such a clutch operation that the rotary cam member is restricted and/or released by entering/deriving the ball into/from the cam groove of the cam shaft.

With employment of this arrangement, the clutch for turning ON/OFF the transfer of power can be arranged with a relatively simple structure.

Also, an opening/closing apparatus of the present invention is featured by that when both the rotary member and the lift cam member are rotated, since the cam shaft is slid via the slide cam member along the shaft direction, the cam shaft executes such a clutch operation that the rotary cam member is restricted and/or released by entering/deriving the ball into/from the cam groove of the cam shaft.

With employment of this arrangement, in the arrangement recited in claim 3, even in such a case that the portable telephone is opened in the manual manner, the driving torque is produced, and thus, the portable telephone can be opened in light manipulating force.

Also, an opening/closing apparatus, according to the present invention, is featured by such an opening/closing apparatus wherein: the opening/closing apparatus is arranged by comprising:

a rotary member, having a substantially hollow tubular shape;

a base, integrally fixed within the rotary member;

a fixing holder, provided with a through hole along a shaft direction thereof;

a driving cam portion, including:
a rotary cam member, which is engaged with the rotary member and which is slidable only along a shaft direction;
a first fixing cam member, which is integrally fixed to the fixing holder and is arranged opposite to one cam face of the rotary cam member;
a second fixing cam member, which is engaged with the fixing holder, which is slidable only along the shaft direction, and which is arranged opposite to the other cam face of the rotary cam member; and
a first compression spring, which is elastically provided between the second fixing cam member and the base;

a holding cam portion, including:
a lift cam member, which is coupled to the fixing holder;
a slide cam member, which is engaged with the base, which is slidable only along the shaft direction, and is arranged opposite to the lift cam member; and
a second compression spring, which is elastically provided between the slide cam member and the holder, the elastic force of the second compression spring is smaller than that of the first compression spring; and

a clutch portion, including:
a ball, which is slidably held by the fixing holder along a radial direction on a plane perpendicular to a shaft and which engages the second fixing cam member at a slidable end thereof; and
a cam shaft, which is slidably held only along the shaft direction by the through hole of the fixing holder, which has a cam groove engaged with the ball, and which is slid with the slide cam member in an integral manner along the shaft direction; and wherein:

the driving cam portion includes two sets of cam members having both the first fixing cam member and the rotary cam member, and both the rotary cam member and the second fixing cam member; and

the driving cam portion provides torque in a wide angle while cams to be meshed with each other are defined as one hill respectively.

In the above arrangement, since the cams of the driving cam portion become one hill and can be freely arranged, the expansion angle of the portable telephone can be set to the wide angle.

Also, a portable telephone apparatus, according to the present invention, is featured by such a portable telephone apparatus comprising: the opening/closing apparatus according to any one of claims 1 to 4.

With employment of the above-described arrangement, it is possible to realize the portable telephone apparatus equipped with the opening/closing apparatus capable of reducing the manipulation force used when the housings are expanded, and at the same time, capable of making compact.

### BRIEF DESCRIPTION OF THE DRAWING

FIG. 1 is a plan view for indicating a portable telephone which uses a compact opening/closing apparatus according to a first embodiment of the present invention;

FIG. 2 is a side view for indicating the portable telephone which uses the compact opening/closing apparatus according to the first embodiment of the present invention;

FIG. 3 is a sectional view for indicating the compact opening/closing apparatus (when housings are under close condition);

FIG. 4 represents operations of cams and the like of the compact opening/closing apparatus according to the first embodiment of the present invention, FIG. 4(A) shows an explanatory diagram as viewed from the side view, FIG. 4(B) is a front view thereof, and FIG. 4(C) is a perspective view of an end portion thereof;

FIG. 5 shows a rotary cam which is employed in the compact opening/closing apparatus according to the first embodiment of the present invention, FIG. 5(A) is a front view, FIG. 5(B) is a side view, taken along an arrow V-B in FIG. 5(A), and FIG. 5(C) is a side view, taken along an arrow V-C in FIG. 5(A);

FIG. 6 shows a slide cam which is employed in the compact opening/closing apparatus according to the first embodiment of the present invention, FIG. 6(A) is a front view, FIG. 6(B) is a side view, taken along an arrow VI-B in FIG. 6(A), and FIG. 6(C) is a side view, taken along an arrow VI-C in FIG. 6(A);

FIG. 7 shows a fixing cam which is employed in the compact opening/closing apparatus according to the first embodiment of the present invention, FIG. 7(A) is a perspective view, FIG. 7(B) is a side view, taken along an arrow VII-B in FIG. 7(A), and FIG. 7(C) is a side view, taken along an arrow VII-C in FIG. 7(A);

FIG. 8 shows a lift cam which is employed in the compact opening/closing apparatus according to the first embodiment of the present invention, FIG. 8(A) is a front view, FIG. 8(B) is a side view, taken along an arrow VIII-B in FIG. 8(A), and FIG. 8(C) is a side view, taken along an arrow VIII-C in FIG. 8(A);

FIG. 9 is a sectional view for indicating an opening operation of the housings (under such a condition that button is pushed) in the compact opening/closing apparatus according to the first embodiment of the present invention;

FIG. 10 is an explanatory diagram for indicating an opening operation of the housings (under such a condition that button is pushed) in the compact opening/closing apparatus according to the first embodiment of the present invention;

FIG. 11(A) and FIG. 11(B) are a torque characteristic diagram and a cam curve diagram as to the compact opening/closing apparatus according to the first embodiment of the present invention, respectively;

FIG. 12 is a sectional view for representing an opening/closing apparatus according to a second embodiment of the present invention;

FIG. 13 is an explanatory diagram for indicating a closing operation of the housings in the compact opening/closing apparatus according to the second embodiment of the present invention;

FIG. 14 is an explanatory diagram for indicating an opening operation of the housings (under such a condition that button is pushed) in the compact opening/closing apparatus according to the second embodiment of the present invention; and

FIG. 15 is a sectional view for representing the conventional opening/closing apparatus.

It should be noted that in the drawings, reference numeral 1 shows an upper-sided (telephone receiving unit side) housing; reference numeral 2 shows a lower-sided (telephone transmitting unit side) housing; reference numeral 3 represents a compact opening/closing apparatus; reference numerals 3A and 6A show driving cam portions; reference numerals 3B and 6B indicate holding cam portions; reference numerals 3C and 6C represent clutch portions; reference numeral 31 indicates a first compression spring; reference numeral 32 shows a second compression spring; reference numeral 41 indicates a rotary member; reference numeral 42 and 61 show rotary cam members (drive-purpose cam); reference numeral 42A shows a concave-shaped inclined cam; reference numeral 42B represents an engaging plane; reference numeral 43 is a base; reference numeral 44 indicates a slide cam member (hold-purpose cam); reference numeral 44A shows a convex-shaped cam; reference numerals 51 and 62 show fixing cam members (drive-purpose cams); reference numeral 51A indicates an inclined cam; reference numeral 51B shows a flat plane; reference numeral 52 indicates a fixing holder; reference numeral 52B indicates an engaging hole; reference numeral 52C represents a flat plane; reference numeral 53 denotes a lift cam member (hold-purpose cam); reference numeral 53A shows a concave-shaped cam; reference numeral 53B represents a D-cut groove; reference numeral 54 shows a cam shaft; reference numeral indicates a cam groove (clutch portion); reference numeral 55 shows a ball (steel ball) (clutch portion); and reference numeral 6 indicates an opening/closing apparatus.

### BEST MODE FOR CARRYING OUT THE INVENTION

Referring now to the accompanying drawings, embodiments of the present invention will be described in detail.

### First Embodiment

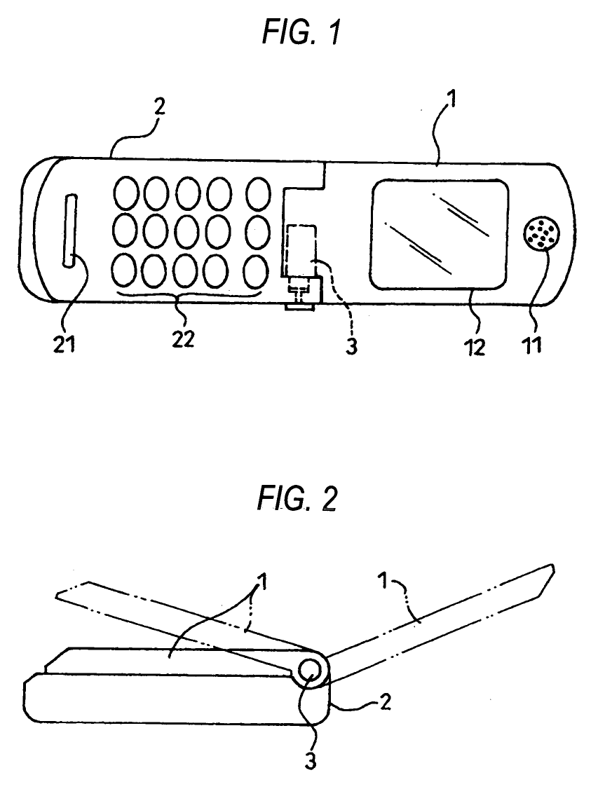

FIG. 1 and FIG. 2 show a portable telephone having a compact opening/closing apparatus according to one embodiment of the present invention. This portable telephone includes a housing (will be referred to “upper-sided housing” hereinafter) 1 having a receiver (receiving unit) 11, another housing (will be referred to as “lower-sided housing” hereinafter) 2 having both a speaker (transmitting unit) 21 and a key unit 22, and a compact opening/closing apparatus 3. The compact opening/closing apparatus 3 constitutes a hinge portion which couples the upper-sided housing 1 to the lower-sided housing 2 in a freely rotatable manner.

The upper-sided housing 1 has a display unit 12 and the like in addition to the receiver (receiving unit) 11. In the case that the portable telephone is used, a button (not shown) of the opening/closing apparatus 3 which constitutes the coupling portion is depressed so as to release the overlapping condition of the upper-sided housing 1 with respect to the lower-sided housing 2.

The lower-sided housing 2 has the key unit 22 and the like in addition to the speaker (transmitting unit) 21.

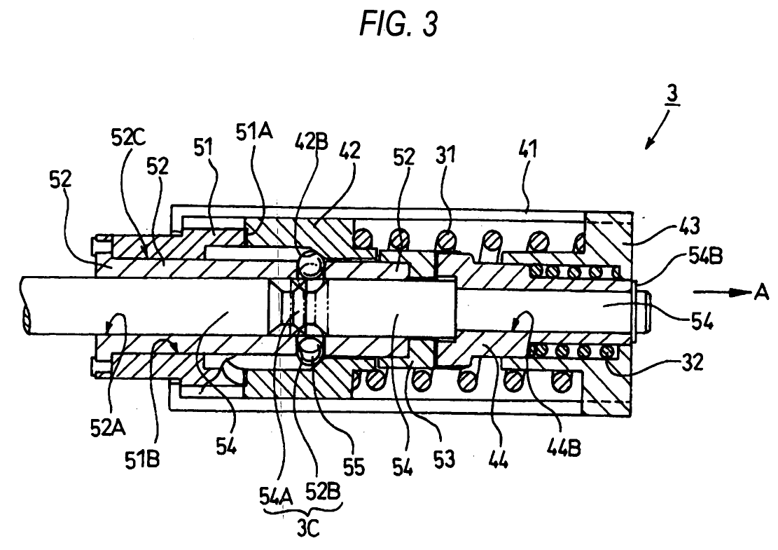

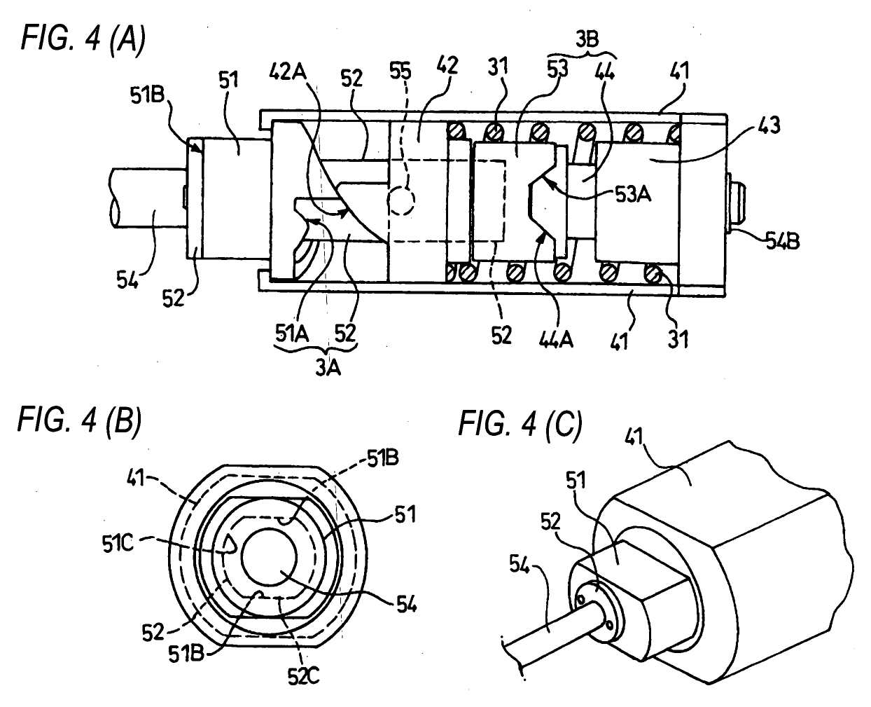

As shown in FIG. 3 and FIG. 4, the compact opening/closing apparatus 3 is provided with a driving cam portion 3A, a holding cam portion 3B, and a clutch portion 3C as a schematic structure. The driving cam portion 3A produces opening force of the housings. The holding cam portion 3B holds a closed attitude and an opened attitude. The clutch portion 3C turns ON/OFF meshing conditions of one pair of cams which are contacted to each other under pressure.

It should be understood that the compact opening/closing apparatus 3 according to the first embodiment of the present invention is arranged in such a manner that one pair of drive-purpose cams have been formed at symmetrical positions of 180 degrees on both a fixing cam member 51 and a rotary cam member 42 (these cam members will be explained later) of the drive cam portion 3A, and furthermore, angles (rotary angles of rotary member) which produce torque become approximately 0 degree to 150 degrees, since operation angles of the cams are restricted only by teeth widths of the cams.

As will be explained later, while this driving cam portion has one pair of drive-purpose cams and a first compression spring 31, this driving cam portion 3A is arranged by that meshing rotation force generated by this first compression spring 31 is used as a power source of opening force for the housings. One pair of drive-purpose cams are constituted by both a rotary cam member 42 and a fixing cam member 51, and are engaged with each other at one place.

As will be explained later, while the holding cam portion 3B has one pair of hold-purpose cams and a second compression spring 32, this holding cam portion 3B applies pressure contact force in such a manner that the holding cam portion 3B applies elastic force so as to hold mutual meshing conditions. One pair of the hold-purpose cams are constituted by a slide cam member 44 and a lift cam member 53, which are separately provided with one pair of the above-described drive-purpose cams on the side of the driving cam portion 3A.

While the clutch portion 3C has a cam shaft 54, and a ball (steel ball) 55, this clutch portion 3C is arranged as follows: That is, the clutch portion 3C releases a meshing condition of the hold-purpose cams in cooperation with a falling operation of the ball 55 into a cam groove 54A of the cam groove 54A of the cam shaft 54 so as to permit an opening operation of the housings. The cam shaft 54 penetrates through a center of the hold-purpose cam of the holding cam portion 3B, and can be freely slid along a shaft direction. The ball 55 is followed to the slide operation of this cam shaft 54, and thus, is entered/derived into/from the cam groove 54A.

Next, a detailed description is made of the compact opening/closing apparatus 3 provided in the portable telephone, according to the first embodiment with reference to FIG. 3 to FIG. 8.

As indicated in FIG. 3 and FIG. 4, the compact opening/closing apparatus 3 has a rotary member 41 and a fixing cam member 51. The rotary member 41 is fixed/coupled on the side of the upper-sided housing 1 in such a manner that the rotary member 41 is integrally rotated with the upper-sided housing 1. The fixing cam member 51 is similarly fixed/coupled on the side of the lower-sided housing 2 in such a manner that the fixing cam member 51 is integrally rotated with the lower-sided housing 2.

Among these members, the rotary member 41 is formed in a hollow substantially cylindrical shape. A rotary cam member 42 is engaged with an inner peripheral plane of the rotary member 41 in such a manner that the rotary cam member 42 can be slid only the shaft direction (for example, serration engagement may be alternatively employed). A base 43 is fixed (coupled) to one edge portion of the rotary member 41 in an integral manner.

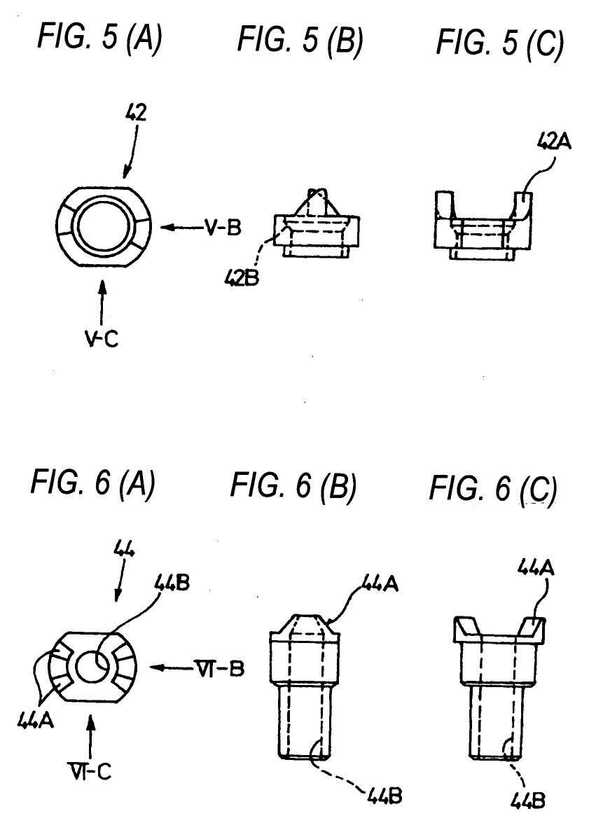

The rotary cam member 42 is formed in a substantially cylindrical shape, while a fixing holder 52 (will be explained later) penetrates through a center portion of the rotary cam member 42. The rotary cam member 42 is freely pivotable along a circumferential direction with respect to this fixing holder 52, and also, is slidably provided along a shaft direction of a cam shaft 54 (will be discussed later) which penetrates through the center portion of this fixing holder 52. Then, as shown in FIG. 4 and FIG. 5, the rotary cam member 42 has one pair of concave-shaped inclined cams 42A at one end thereof, and also, has an engaging plane 42B (refer to FIG. 3 and FIG. 5) on an inner peripheral wall plane thereof. One pair of these concave-shaped inclined cams 42A are arranged opposite to each other in such a manner that these concave-shaped inclined cams 42A are engaged with the above-described inclined cam 51A. The sliding operation of the engage plane 42B along the shaft direction is fitted by the ball (steel ball) 55 which will be discussed later.

The base 43 has a substantially cylindrical shape with a claw. Since the slide cam member 44 is engaged (otherwise, may be alternatively serration-engaged) with an inner peripheral plane of this base 43 in a D-cut shape in such a manner that this base 43 can be slid along the shaft direction, this base 43 and the slide cam member 44 (will be explained later) are rotated with the rotary member 41 in an integral manner.

As shown in FIG. 4 and FIG. 6, the slide cam member 44 has one pair of convex-shaped cams 44A at one end thereof and a through hole 44B along the shaft direction. The one pair of the convex-shaped cams 44A are arranged at opposite positions in such a manner that one pair of these convex-shaped cams 44A are fitted with convex-shaped cams 53A (see FIG. 8) which will be discussed later. A cam shaft 54 (will be explained later) penetrates the through hole 44B.

On the other hand, a fixing holder 52 is integrally coupled to the fixing cam member 51, and also, a lift cam member 53 is integrally coupled to the fixing holder 52. Three sets of the fixing cam member 51, the fixing holder 52, and the lift cam member 53 are operated in an integral manner.

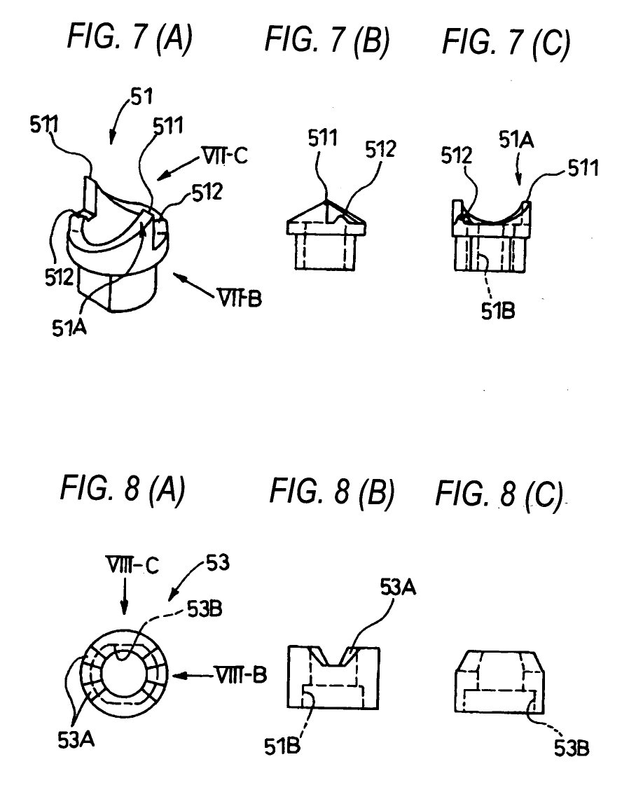

Further, as shown in FIG. 4 and FIG. 7, this fixing cam member 51 has one pair of inclined cams 51A at one end thereof, while the inclined cams 51A have specific pattern shapes. One pair of the concave-shaped inclined cams 42A of the above-explained rotary cam member 42 is continuously meshed with the inclined cams 51A by way of the elastic force of the first compression spring 31.

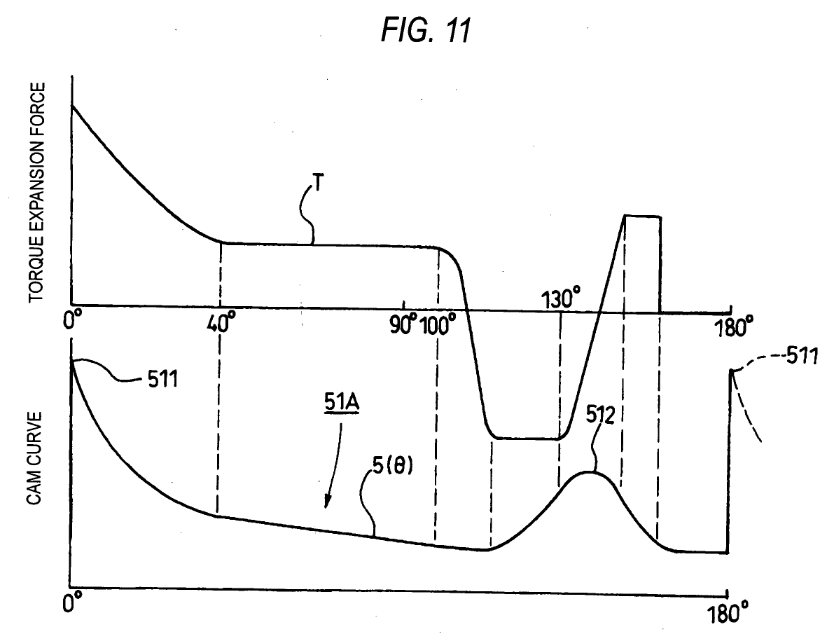

As shown in FIG. 7 and FIG. 11(B), in the inclined cam 51A, one pair of cam curves “f(θ)” having a predetermined pattern which is formed in a point symmetrical manner by shifting a phase by 180 degrees. Precisely speaking, as shown in FIG. 11(B), a closed-status holding-purpose projection 511 and a braking-purpose projection 512 are respectively formed at positions which correspond to an opening angle (θ) being zero degree, and another opening angle (θ) being 130 degrees to 150 degrees which is slightly in front of 180 degrees.

A through hole 51C (refer to FIG. 4(B)) is formed on the fixing cam member 51 so as to pass from one end thereof to the other end thereof. Further, a flat plane 51B (refer to FIG. 7(A) and FIG. 7(C)) is formed on an inner peripheral plane of the through hole 51C, while this flat plane 51B is engaged with a flat plane 52C formed on a portion of an outer peripheral plane of a fixing holder 52 (will be explained later). A sectional shape of the through hole 51C represents a substantially bale shape (or substantially D shape). It should also be understood that an outer peripheral plane side of this fixing cam member 51 is fixed on the side of the lower-sided housing 2.

The fixing folder 52 is formed in a substantially cylinder shape with a claw, in which a through hole 52A is formed along a shaft direction. As previously explained, the outer peripheral section where the flat plane 52C is formed on a portion of the outer peripheral plane represents the substantially bale shape (or substantially D shape). Then, in this fixing holder 52, a cam shaft 54 is slidably inserted into the through hole 52A along the shaft direction. Also, the ball 55 is slidably inserted into an engaging hole 52B along a circumferential direction, and this engaging hole 52B is pierced/formed in a plane perpendicular to this through hole 52A along a radial direction.

As indicated in FIG. 8, the lift cam member 53 has one pair of concave-shaped cams 53A on one end thereof, and a D-cut groove 53B is formed in the other end thereof in such a manner that the lift cam member 53 is integrally rotated with the fixing holder 52.

The cam shaft 54 is fixed by such a stopping ring 54B as shown in FIG. 3 and FIG. 4 in order that the cam shaft 54 is integrally slid with respect to the slide cam member 44 along the shaft direction. A cam groove 54A is cut/formed in an outer peripheral plane of an intermediate portion of this cam shaft 54. The ball 55 which is entered into the engaging hole 52B of the fixing holder 52 is dropped into the cam groove 54A, when the button (not shown) is pushed so as to slide the cam shaft 54 along a direction of an arrow “A.”

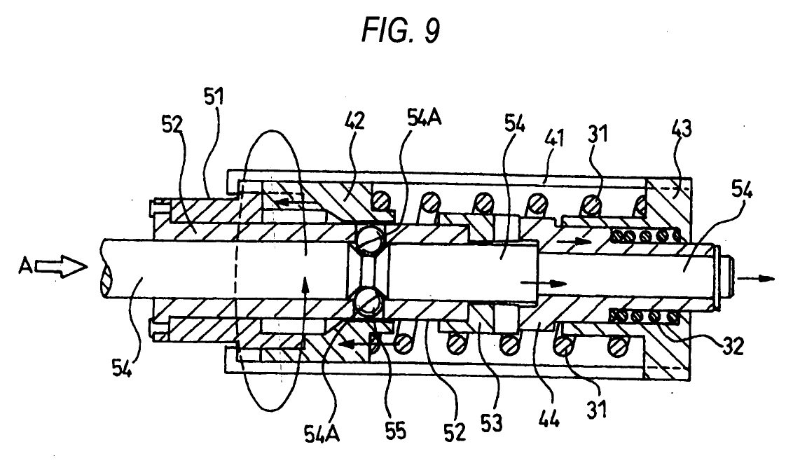

Next, operations of the above-explained compact opening/closing apparatus 3 according to the first embodiment of the present invention will now be described with reference to FIG. 9 to FIG. 11.

(I) Open by Manipulating the Button:

(1) In the beginning stage, when the portable telephone is folded in order to be stored while this portable telephone is not under operation in the normal state, as shown in FIG. 3, the ball 55 is being engaged and abuts against the engaging plane 42B. Since the ball 55 impedes meshing operation between the fixing cam member 51 and the rotary cam member 42, opening force is not produced. At this time, as represented in FIG. 4(A), both the inclined plane of the concave-shaped cam 53A of the lift cam member 53 and the inclined plane of the convex-shaped cam 44A of the slide cam member 44 hold the meshing condition by way of the second compression spring due to the elastic force to be exerted along a left direction (namely, direction opposite to direction “A” shown in FIG. 3). As a result, the upper-sided housing and the lower-sided housing maintain the completely closed attitude.

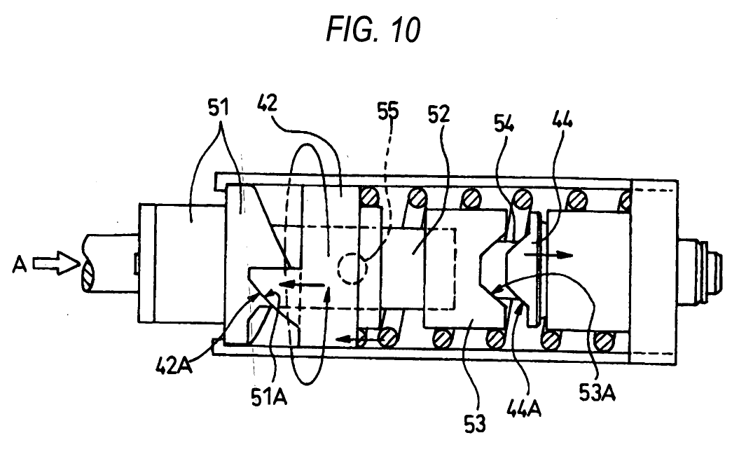

(2) Next, in FIG. 3, when the button (not shown) is pushed so as to slide the cam shaft 54 along the direction of the arrow “A”, the meshing condition between the lift cam member 53 and the slide cam member 44 is released as indicated in FIG. 10. Then, as shown in FIG. 9, the ball 55 is dropped into the cam groove 54A. As a consequence, the restriction of the rotary cam member 42 made by the ball 55 on the engaging portion 42B is released, and elastic force is exerted by the first compression spring 31 along the left direction.

(3) As a result, torque is produced from the rotary cam member 42 which is depressed by this elastic force along the left direction. Also, the cam face of the concave-shaped inclined cam 42A is transported in a pivotable manner along the cam face of the convex-shaped inclined cam 51A of the fixing cam member 51 in order to release the depression force.

(4) Accordingly, in FIG. 9, the rotary cam member 42 is slid along the left direction while the rotary cam member 42 is pivotally moved along the outer peripheral plane of the fixing holder 52. However, as to the rotary member 41 (and upper-sided housing 1 on which this rotary member 41 is fixed) which causes this rotary cam member 42 to be engaged, the sliding operation along the shaft direction is blocked and the pivotable operation along only the circumferential direction of the shaft is allowed. As a consequence, the rotary member 41 is not slid along this shaft direction, but is pivotably moved along the same direction as the pivotable direction of the rotary cam member 42. As a result, the upper-sided housing 1 (not shown in this drawing) is pivotably moved, and therefore, such an opening operation that the housings of the portable telephone are expanded may be carried out.

(II) Open by Manual Operation:

(1) In the case that the portable telephone is opened in a manual manner, in FIG. 3 and FIG. 4, when the slide cam member 44 is rotated via the rotary member 41 by the upper-sided housing 1 (not shown in this drawing), both the slide cam member 44 and the cam shaft 54 are slid along the direction “A” by the lift cam member 53.

(2) Then, when this cam shaft 54 is slid, since the ball 55 is dropped into the cam groove 54A, restriction of the rotary cam member 42 by the ball 55 in the engaging portion 42B is released. Then, as shown in FIG. 10, the fixing cam member 51 is meshed with the rotary cam member 42, so that torque capable of assisting the manual expansion of the housings is produced. As a result, the upper-sided housing 1 is pivotably moved, and thus, the opening operation is carried out by which the housings of the portable telephone are expanded.

(III) Folding Operation of Manual Operation:

(1) Conversely, in the case that the portable telephone is folded in a manual manner, as indicated in FIG. 9 and FIG. 10, when rotating force is transferred from the upper-sided housing 1 (not shown in this drawing) via the rotary member 41, the rotary cam member 42 is rotated, and at the same time, is slid in the direction “A” along the convex-shaped inclined cam 51A of the fixing cam member 51 so as to release the restriction of the ball 55.

(2) As shown in FIG. 3, the ball 55 is pushed to be raised along the cam groove 54A by both the second compression spring 32 and the cam shaft 54. As shown in FIG. 4, the rotary cam member 42 is again engaged under such a condition that this rotary cam member 42 is not meshed (not fitted) with the fixing cam member 51 by the ball 55, and further, both the lift cam member 53 and the slide cam member 44 are also and again meshed with each other (are fitted).

(3) In this case, since the depressing force of the button may be merely equal to such a light button manipulation force irrespective of the first compression spring 31 having the strong elastic force which produces the rotating force, a so-called “one-touch opening operation” can be realized in low weight. The light button manipulation force is substantially equal to such a manipulation force capable of enduring the weak elastic force of the second compression spring 32.

Referring now to FIG. 11, a description is made of a change in torque which corresponds to the opening degree “θ” of the upper-sided housing 1. In this case, it should also be noted that FIG. 11(A) indicates a rotation torque curve of the compact opening/closing apparatus 3 according to the first embodiment. Assuming now that a cam curve of the inclined cam 51A shown in FIG. 11(B) is equal to “f(θ)”, this torque “T” may be conducted by the following formula:
T=k·[df(θ)/dθ].

(I) When the upper-sided housing 1 is opened from 0 degree up to 40 degrees, since the cam curve “f(θ)” corresponding to the expansion requires large torque expansion force corresponding to, namely, the closed status holding-purpose projection 511, rotation energy required to expand this upper-sided housing 1 must be applied from an external source.

(II) Next, when the upper-sided housing 1 is expanded from 40 degrees up to 100 degrees, a cam curve “f(θ)” corresponding to this expansion has a substantially flat shape, and a changing rate of the inclination is similarly set to a small changing rate, which is suppressed to approximately a sliding resistance which is produced in the fixing cam member 51 and the rotary cam member 42. As a result, even while the opening force exerted from the external source is not required, the upper-sided housing 1 can be automatically opened by utilizing the elastic force of the first compression spring 31.

(III) Then, when the upper-sided housing 1 is expanded from 100 degrees up to approximately 130 degrees, in order to reduce shocks applied when the upper-sided housing 1 is fully opened (opened at angle of 180 degrees), the braking-purpose projection 512 corresponding thereto is provided. A climbing portion of this braking-purpose projection 512 corresponds to this angle. Then, since a changing rate of an inclination as to the climbing portion of this braking-purpose projection 512 is set in such a manner that this changing rate is gradually increased, the torque expansion force is also increased.

As a result, with respect to large inertia force which is exerted to the upper-sided housing 1 under expanding operation (tried to be opened), braking force against this inertia force may be applied, and thus, a braking operation becomes effective, so that rotation (expansion) energy can be absorbed. As a consequence, shocks which are produced at the final stage when the upper-sided housing 1 is expanded can be canceled.

(VI) Finally, when the upper-sided housing 1 is expanded over an angle of 130 degrees, since the upper-sided housing 1 passes through a down portion of the braking-purpose projection 512, a changing rate of the inclination is also equal to zero after the upper-sided housing 1 has passed this down portion, and the torque expansion force is no longer required. As previously described, if the upper-sided housing 1 is expanded up to approximately 180 degrees and then the upper-sided housing 1 is completely opened, then the attitude (expansion condition) when the upper-sided housing 1 is fully opened can be directly maintained unless such a large torque is applied which can exceed the torque expanding torque corresponding to the above-explained braking-purpose projection 512.

### Second Embodiment

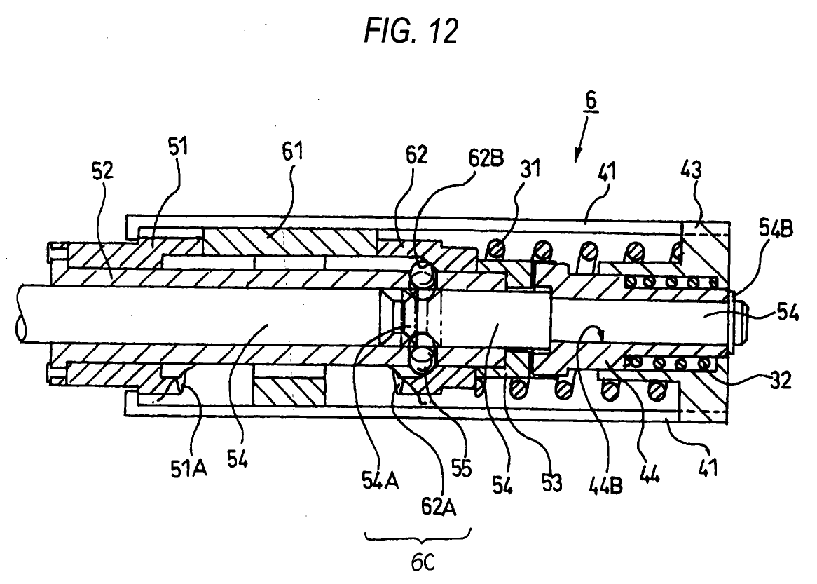

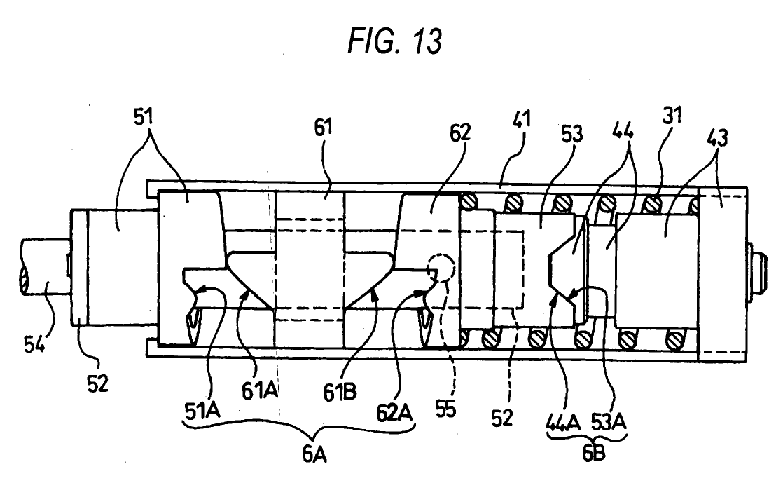

Referring to FIG. 12 to FIG. 14, a description is made of a second embodiment of the present invention. It should be noted that the same reference numerals shown in the first embodiment will be employed or those for denoting the same, or similar structural elements of this second embodiment so as to avoid duplicated explanations thereof. FIG. 12 and FIG. 13 show a portable telephone having an opening/closing apparatus 6 according to the second embodiment of the present invention. Similar to the compact opening/closing apparatus 3 of the portable telephone according to the first embodiment, the opening/closing apparatus 6 of the portable telephone according to this second embodiment is mainly arranged by employing a driving cam portion 6A, a holding cam portion 6B, and a clutch portion 6C. The diving cam portion 6A is provided with drive-purpose cams which are meshed with each other at two right and left places, which is different from the first embodiment.

In this second embodiment of the present invention, assuming now that cams which are meshed (fitted) with each other in the driving cam portion 6A are one hill, and as will explained later, a lack of torque is compensated by two sets of cams, so that a rotation angle is arranged larger than, or equal to 180 degrees. These two sets of cams are constituted by both the fixing cam member 51 and the rotary cam member 61, and also, both the rotary cam member 61 and the fixing cam member 62.

As will be explained later, different from the first embodiment, the driving cam portion 6A has drive-purpose cams and the first compression spring 31. The drive-purpose cams are meshed with each other at two positions, and are arranged by the fixing cam member 51, the rotary cam member 61, and the fixing cam member 62. The meshing rotation force which is exerted by this first compression spring 31 is employed as a power source of the opening force of the upper-sided housing 1.

Similarly, in this second embodiment, an upper-sided housing 1 is fixed in such a manner that the upper-sided housing 1 is integrally rotated with a rotary member 41, and a lower-sided housing 2 is fixed in such a way that the lower-sided housing 2 is integrally rotated with a fixing cam member 51.

The holding cam portion 6B is arranged in a similar manner to that of the first embodiment, and has one pair of hold-purpose cams and a second compression spring 32, this holding cam portion 6B applies pressure contact force in such a manner that the holding cam portion 6B applies elastic force of the second compression spring 32 so as to hold mutual meshing conditions with respect to these cams. Similar to the first embodiment, one pair of the hold-purpose cams are constituted by a slide cam member 44 and a lift cam member 53.

The clutch portion 6C is constructed in a similar manner to that of the first embodiment. While the clutch portion 6C has a cam shaft 54, and a ball (steel ball) 55, this clutch portion 6C is arranged as follows: That is, the clutch portion 6C releases a meshing condition of the hold-purpose cams in cooperation with a falling operation of the ball 55 into a cam groove 54A of the cam shaft 54 so as to permit an opening operation of the housings. The cam shaft 54 penetrates through a center of the hold-purpose cam of the holding cam portion 6B, and can be freely slid along a shaft direction. The ball 55 is followed to the slide operation of this cam shaft 54, and thus, is entered/derived into/from the cam groove 54A.

A base 43 having the same structure as that of the first embodiment is mounted on one end side of the rotary member 41, and is engaged with this rotary member 41 in such a manner that a rotary cam member 61 can be slid only along the shaft direction. As a consequence, similar to the first embodiment, this base 43 is also rotated with the upper-sided housing (not shown in this drawing) and the rotary member 41 in an integral manner.

As indicated in FIG. 13, the slide cam member 44 has the same structure as that of the first embodiment. The slide cam member 44 has one pair of convex-shaped cams 44A at one end (left end in FIG. 13) and a through hole 44B along the shaft direction, as shown in FIG. 12. One pair of these convex-shaped cams 44A are engaged with the above-described convex-shaped cams 53A. A cam shaft 54 penetrates the through hole 44B. It should also be understood that similar to the first embodiment, this cam shaft 54 is also fixed by a stopping ring 54B, or the like in such a way that the cam shaft 54 is integrally slid along the shaft direction with respect to the slide cam member 44.

A fixing cam member 51 and a fixing cam member 62 have a convex-shaped inclined cam 51 and an inclined cam 62A, which have been formed on one end thereof over an entire circumference by 360 degrees.

Among these structural elements, similar to the first embodiment, a flat plane is formed on the fixing cam member 51, the sectional area of which becomes a substantially bale shape (a substantially D shape), in order that both a fixing holder 52 and a lift cam 53 are coupled to each other in an integral form and are integrally rotated with the lower-sided housing (not shown in this drawing).

On the other hand, similar to the first embodiment, an engaging plane 62B (see FIG. 12) is formed on an inner peripheral wall of the fixing cam member 62. The sliding operation along the shaft direction is retained by the ball 55 on the engaging plane 62B.

The lift cam member 53 has one pair of concave-shaped cams 53A at one end (right end in FIG. 13). A D-cut groove is formed in the other end (left end in FIG. 13) of the lift cam member 53 in order that the other end thereof is rotated with the fixing holder 52 in the integral form. It should also be noted that the fixing holder 52 has the same structure as that of the first embodiment.

As indicated in FIG. 13, the rotary cam member 61 has a concave-shaped inclined cam 61A which is meshed with the above-described inclined cam 51A on one end thereof (left end in FIG. 13). Also, the rotary cam member 61 has a concave-shaped inclined cam 61B which is meshed with the above-described inclined cam 62A on the other end thereof (right end in FIG. 13).

Next, operations of the above-explained compact opening/closing apparatus 6 according to the second embodiment of the present invention will now be described with reference to FIG. 12 to FIG. 14.

(I) Open by Manipulating the Button:

As shown in FIG. 12, when the portable telephone is folded, the ball 55 is retained and abuts against the engaging plane 62B. Since the ball 55 impedes meshing operation between the fixing cam member 62 and the rotary cam member 61, as shown in FIG. 13, rotating force for opening the housing is not produced. Namely, in this case, as represented in FIG. 13, both the inclined plane of the concave-shaped cam 53A of the lift cam member 53 and the inclined plane of the convex-shaped cam 44A of the slide cam member 44 are meshed with each other (fitted to each other) by way of compressing force of the compression spring 31, and thus, generate such a holding force by which both the upper-sided housing and the lower-sided housing hold completely closed attitudes.

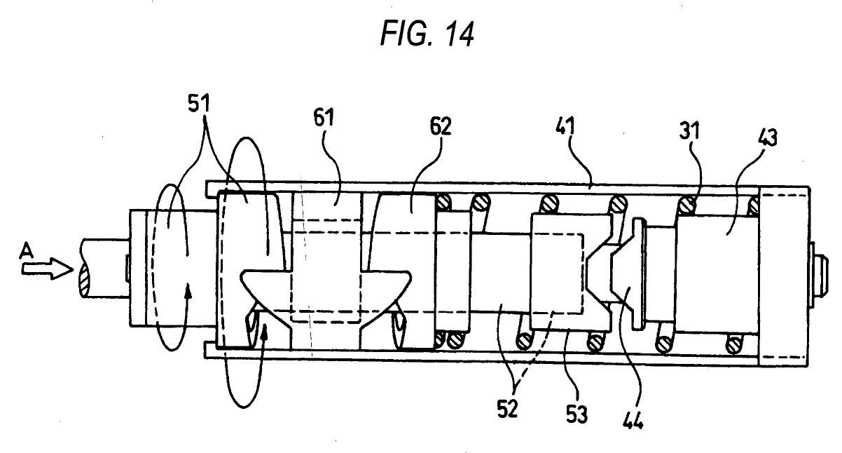

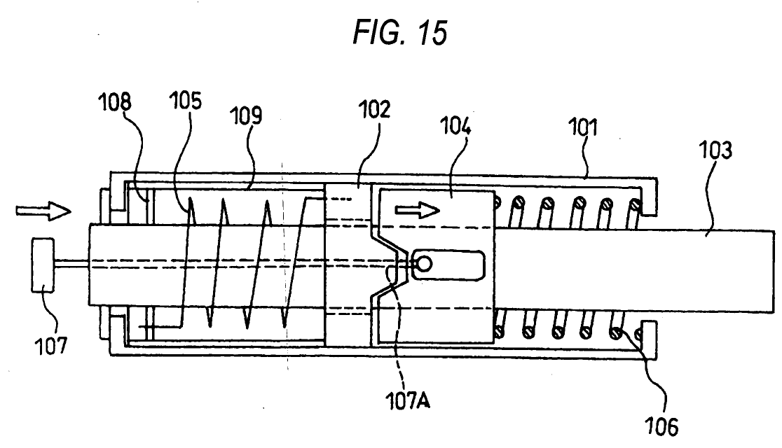

Under this condition, as represented in FIG. 14, when the button (not shown) is pushed so as to slide the cam shaft 54 along the direction of the arrow “A”, the meshing condition between the lift cam member 53 and the slide cam member 44 is released, and the ball 55 is dropped into the cam groove 54A (namely, same condition of FIG. 9 in the first embodiment). As a result, the restriction condition of the rotary cam member 61 with respect to the engaging plane 62B is released, and meshing force (fitting force) among three structural members, namely, the fixing cam member 51, the rotary cam member 61, and the fixing cam member 62 is produced, so that both the upper-sided housing and the lower-sided housing of the portable telephone are expanded.

(II) Open by Manual Operation:

Also, in the case that the upper-sided housing 1 of the portable telephone is expanded from such a condition that the housings are closed as represented in FIG. 12 and FIG. 13 in the manual operation, if the slide cam member 44 is rotated via the rotary member 41 by the rotation operation of this upper-sided housing 1, then the cam shaft 54 is slid along the direction “A” by the lift cam member 53.

Then, in FIG. 12, when this cam shaft 54 is slid, since the ball 55 is dropped into the cam groove 54A, restriction of the fixing cam member 62 by the ball 55 in the engaging portion 62B is released. As a result, as indicated in FIG. 14, the fixing cam member 51 is meshed with the rotary cam member 41, and also, the rotary cam member 61 is meshed with the fixing cam member 62 (fitted to each other), so that torque capable of assisting the expansion by the manual manner is produced.

(III) Folding Operation of Manual Operation:

Conversely, in such a case that the upper-sided housing (not shown in this drawing) of the portable telephone is manually folded from such a condition that the housing is opened as shown in FIG. 14, when rotating force is transferred via the rotary member 41 to the rotary cam member 61 by way of a reverse rotating operation of this upper-sided housing in a sense opposite to the above-explained sense, the rotary cam member 61 is rotated, and at the same time, is slid in the direction “A” along the convex-shaped inclined cam 51A of the fixing cam member 51. Then, the fixing cam member 62 is also slid along the direction “A” by the concave-shaped inclined cam 61B of the rotary cam member 61 so as to release the restriction condition of the ball 55.

As a result, this ball 55 is pushed to be raised along the cam groove 54A by both the compression spring 32 and the cam shaft 54. The fixing cam member 62 is again engaged on the engaging portion 62B under such a condition that this fixing cam member 62 is not meshed (not fitted) with the rotary cam member 61 by the ball 55. On the other hand, both the lift cam member 53 and the slide cam member 44 are again meshed with each other, as indicated in FIG. 13.

In accordance with the second embodiment, assuming now that cams which are meshed with each other in the driving cam portion 6A are one hill, and a lack of torque is compensated by two sets of cams, so that a rotation angle is arranged larger than, or equal to 180 degrees. These two sets of cams are constituted by both the fixing cam member 51 and the rotary cam member 61, and also, both the rotary cam member 61 and the fixing cam member 62.

While the present invention is described in detail and with reference to the specific embodiments, it is apparent that the present invention may be modified and changed without departing from the technical spirit and the technical scope of the invention by those skilled in the art.

The present patent application is made based upon Japanese Patent Application No. 2002-198634 filed on Jul. 8, 2002, and the contents of which are incorporated herein as reference.

### INDUSTRIAL APPLICABILITY

As previously described, in the opening/closing apparatus of the present invention, the clutch portion is formed by the second compression spring having the weak elastic force irrespective of the first compression spring having the strong spring force, which produces the drive torque. As a result, in the portable telephone equipped with this opening/closing apparatus, when the portable telephone is expanded, the button is merely pushed by stronger force than that of the second compression spring, and the manipulation force used when the housings are expanded can be reduced, so that the manipulation can be readily performed.

Also, in the portable telephone of the present invention, even in such a case that the portable telephone is expanded in the manual manner, the driving torque is produced, and thus, the portable telephone can be opened in light manipulating force.

Also, in the portable telephone of the present invention, since the cams of the driving cam portion become one hill and can be freely arranged, the expansion angle of the portable telephone can be set to the wide angle.

1. An opening/closing apparatus for automatically releasing/opening two housings which are coupled to each other by a hinge portion and are capable of being opened/closed by manipulating a button, the opening/closing apparatus, comprising:
a rotary member, having a substantially hollow tubular shape;
a base, integrally fixed within the rotary member;
a fixing holder, provided with a through hole along a center axis direction thereof;
a driving cam portion, including:
a rotary cam member, which is engaged with the rotary member and which is slidable only along a shaft direction;
a fixing cam member, which is integrally fixed to the fixing holder and is arranged opposite to the rotary member; and
a first compression spring, which is elastically provided between the rotary cam member and the base;
a holding cam portion, including:
a lift cam member, which is coupled to the fixing holder;
a slide cam member, which is engaged with the base, which is slidable only along the shaft direction, and is arranged opposite to the lift cam member; and
a second compression spring, which is elastically provided between the slide cam member and the base, the elastic force of the second compression spring is smaller than that of the first compression spring; and
a clutch portion, including:
a ball, which is slidably held by the fixing holder along a radial direction on a plane perpendicular to an axis and which engages the rotary cam member at a slidable end thereof; and
a cam shaft, which is slidably held only along the shaft direction by the fixing holder, which has a cam groove engaged with the ball, and which is slid with the slide cam member in an integral manner along the shaft direction.

2. The opening/closing apparatus as set forth in claim 1 wherein:
the rotary cam member includes a retaining portion which is retained by the ball, and the rotary cam is constituted so as to execute such a clutch operation that the rotary cam member is restricted and/or released by entering/deriving the ball into/from the cam groove of the cam shaft.

3. The opening/closing apparatus as set forth in claim 1 wherein:
when both the rotary member and the lift cam member are rotated, since the cam shaft is slid via the slide cam member along the shaft direction, the cam shaft executes such a clutch operation that the rotary cam member is restricted and/or released by entering/deriving the ball into/from the cam groove of the cam shaft.

4. An opening/closing apparatus, comprising:
a rotary member, having a substantially hollow tubular shape;
a base, integrally fixed within the rotary member;
a fixing holder, provided with a through hole along a shaft direction thereof;
a driving cam portion, including:
a rotary cam member, which is engaged with the rotary member and which is slidable only along a shaft direction;
a first fixing cam member, which is integrally fixed to the fixing holder and is arranged opposite to one cam face of the rotary cam member;
a second fixing cam member, which is engaged with the fixing holder, which is slidable only along the shaft direction, and which is arranged opposite to the other cam face of the rotary cam member; and
a first compression spring, which is elastically provided between the second fixing cam member and the base;
a holding cam portion, including:
a lift cam member, which is coupled to the fixing holder;
a slide cam member, which is engaged with the base, which is slidable only along the shaft direction, and is arranged opposite to the lift cam member; and
a second compression spring, which is elastically provided between the slide cam member and the holder, the elastic force of the second compression spring is smaller than that of the first compression spring; and
a clutch portion, including:
a ball, which is slidably held by the fixing holder along a radial direction on a plane perpendicular to a shaft and which engages the second fixing cam member at a slidable end thereof; and
a cam shaft, which is slidably held only along the shaft direction by the through hole of the fixing holder, which has a cam groove engaged with the ball, and which is slid with the slide cam member in an integral manner along the shaft direction; and wherein:
the driving cam portion includes two sets of cam members having both the first fixing cam member and the rotary cam member, and both the rotary cam member and the second fixing cam member; and
the driving cam portion provides torque in a wide angle while cams to be meshed with each other are defined as one hill respectively.

5. A portable telephone apparatus, comprising:
the opening/closing apparatus according to any one of claim 1 to 4.
